(19) United States
(12) Patent Application Publication
(10) Pub. No.: US 2006/0116903 A1
(43) Pub. Date: Jun. 1, 2006

(54) Systems and methods for providing insurance coverage to a customer

(75) Inventor: Manuel Becerra, Miami, FL (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Assurant Solutions

(21) Appl. No.: 11/001,356

(22) Filed: Nov. 30, 2004

(51) Int. Cl. G06Q 10/00; G06Q 50/00

(52) U.S. Cl. 705/2

(57) ABSTRACT

A method of providing insurance coverage to a customer comprising the steps of: (1) selling a debt protection contract to a customer; and (2) in response to the customer purchasing the debt protection contract, providing third-party-paid insurance coverage to the customer at no substantial cost to the customer. This may be done, for example, to avoid the need to have a licensed insurance agent available when the customer acquires the insurance product. In various embodiments of the invention, the debt protection contract may be, for example, a debt deferment contract or a debt cancellation contract.

### BACKGROUND OF THE INVENTION

1. Background Regarding Debt Cancellation and Debt Deferment Policies

A typical debt protection contract is associated with a credit account (such as a credit card account) issued by a creditor to a borrower (i.e., a customer). Debt protection contracts include, for example, debt cancellation contracts, debt deferment contracts, and debt holiday contracts.

Typical debt cancellation contracts serve to cancel all or part of the debt or interest owed by the borrower to the creditor if the borrower dies, becomes disabled, becomes involuntarily unemployed, or takes a specified leave of absence (or if some other specified event occurs). A typical debt deferment contract serves to defer all or a part of the debt or interest owed by the borrower to the creditor in the event that the creditor becomes disabled, becomes involuntarily unemployed, takes a specified leave of absence, or obtains a divorce (or if some other specified event occurs). Similarly, a typical debt holiday contract serves to defer interest and/or principal payments associated the credit account (or part of these payments) for a certain period of time if a certain event occurs (e.g., the cardholder becomes disabled, becomes involuntarily unemployed, takes a specified leave of absence, obtains a divorce, or if some other specified event occurs.)

2. Background Regarding the Sale of Insurance Products

Most states have laws in place specifying that only a licensed insurance agent may sell insurance products. As a result, retailers and/or creditors who wish to provide insurance type benefits to a customer at a point of sale must arrange for an insurance agent to be present at the point of sale when the customer purchases the insurance. This can be expensive and inconvenient for the retailer.

There is currently a need for improved types of insurance and non-insurance products, and for improved methods for conveniently and inexpensively providing insurance and non-insurance products to customers.

### SUMMARY OF THE INVENTION

One embodiment of the invention comprises a method for providing a third-party paid insurance product to a customer. This may be done, for example, to avoid the need to have a licensed insurance agent available when the customer is provided the benefits of the insurance product.

More particularly, a method of providing insurance coverage to a customer according to one embodiment of the invention comprises the steps of: (1) selling a debt protection contract to a customer; (2) purchasing insurance coverage that provides benefits to the customer, and (3) in response to the customer purchasing the debt protection contract, providing the insurance coverage to the customer. In certain embodiments of the invention, the step of providing the insurance coverage to the customer is done at no cost, or substantially no cost, to the customer. In various of the invention, the step of providing the insurance coverage to the customer may done at a cost to the customer. For example, in certain embodiments of the invention, the insurance coverage may be provided to the customer at the current market value for the insurance coverage, or at a discounted cost (e.g., a discounted cost that is substantially below market value for the insurance coverage).

In various embodiments of the invention, the insurance coverage may be, for example, property insurance coverage, casualty insurance coverage, or health insurance coverage. Similarly, in various embodiments of the invention, the debt protection contract may be, for example, a debt deferment contract, a debt cancellation contract, a debt protection contract, or a hybrid of any these types of contracts.

In a particular embodiment of the invention, the step of providing the insurance coverage to the customer is done by a party that has an insurable interest in property that is covered by the insurance coverage. In one embodiment, this party has obtained an insurable interest in the property by virtue of a relationship between the party and the customer.

Also, in a particular embodiment of the invention, the step of providing the insurance coverage to the customer is done by a party that has an insurable interest in a person that is covered by the insurance coverage. In one embodiment, this party has obtained an insurable interest in the person by virtue of a relationship between the party and the customer.

A debt protection plan according to a particular embodiment of the invention comprises: (1) debt protection coverage that is paid for by a first entity; and (2) insurance coverage that is paid for by a second entity. In one embodiment of the invention, the debt protection plan is referenced by a single identification indicia. In a particular embodiment of the invention, the debt protection coverage comprises a debt cancellation contract. In another embodiment, the debt protection coverage comprises a debt deferment contract. In a further embodiment of the invention, the debt protection contract is a debt holiday contract.

### BRIEF DESCRIPTION OF THE DRAWINGS

Having thus described the invention in general terms, reference will now be made to the accompanying drawings, wherein:

FIG. 1 is a flow chart depicting a method, according to a particular embodiment of the invention, of providing insurance to a customer.

### DETAILED DESCRIPTION OF VARIOUS EMBODIMENTS OF THE INVENTION

The present invention will now be described more fully hereinafter with reference to the accompanying drawings, in which various embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Overview of Various Aspects of the Invention

One embodiment of the invention comprises a method for providing a third-party paid insurance product to a customer. As noted above, this may be done, for example, to avoid the need to have a licensed insurance agent available when a retailer or creditor wishes to provide the customer with the benefits of an insurance product.

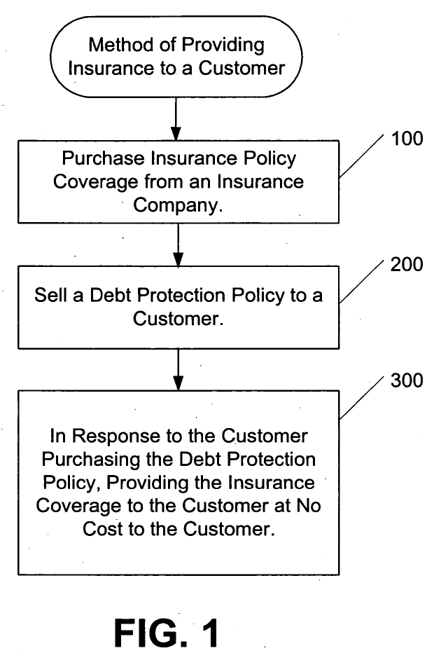

More particularly, as may be understood from FIG. 1, a method of providing insurance coverage to a customer according to a particular embodiment of the invention comprises a first step 100 of purchasing an insurance policy from an insurance company to provide benefits to a customer purchasing a debt protection contract. This method further comprises a second step 200 of selling a debt protection contract to the customer. In addition, the method further comprises a third step 300 of, in response to the customer purchasing the debt protection contract, providing third-party-paid insurance coverage to the customer at no cost to the customer. In one embodiment of the invention, the debt protection contract is a debt deferment contract. In another embodiment of the invention, the debt protection contract is a debt cancellation contract. In a further embodiment of the invention, the debt protection contract is a debt holiday contract. Steps 100 and 200 above may be performed in any convenient order.

In a particular embodiment of the invention, the debt protection contract is associated with a credit card account (or other credit account) issued to the customer by a creditor, and the third-party-paid insurance coverage is paid for by the creditor. The third-party-paid insurance coverage may be, for example, property insurance or casualty insurance.

In another embodiment of the invention, the debt protection contract is associated with a credit card account (or other credit account) issued to the customer by a creditor, and the third party paid insurance coverage is paid for by a retailer selling the merchandise that will be financed by the creditor.

In one embodiment of the invention, the third-party-paid insurance coverage provides for one or more payments to be made (e.g., to the customer or other designated party) in response to the occurrence of one or more of the events that trigger the customer's debt protection contract. For example, the third-party-paid insurance coverage may provide for a lump sum payment to be made to the customer in response to the customer: (1) becoming disabled; (2) becoming involuntarily unemployed; (3) taking a specified leave of absence from their job; or (4) obtaining a divorce.

In another embodiment of the invention, the debt protection contract is associated with a credit account (such as a credit card account) and provides for one or more payments to be made in response to property that was purchased by the customer and charged to the credit account: (1) being damaged; (2) mysteriously disappearing; or (3) being lost. In various embodiments of the invention, such payments may be made to provide for repair or replacement of the property at issue. The payments may be made, for example, to the customer or another designated party.

Provision of the Insurance Coverage

The third-party-paid insurance coverage described above may be provided to the customer in any suitable manner. For example, the third-party-paid insurance coverage may be provided automatically to the customer in response to the customer purchasing a debt protection contract. Alternatively, the insurance may be provided after for the customer purchases the debt protection contract. For example, in one embodiment of the invention, the customer is automatically sent enrollment forms after purchasing the debt protection contract. The insurance coverage is then activated in response to the receipt of the completed enrollment forms from the customer. Where permitted, the third-party-paid insurance coverage may be provided (e.g., at the request of a retailer or creditor) to customers who call to cancel an existing debt protection contract and who, in exchange for the third-party-paid insurance coverage, agree not to cancel the existing debt protection contract.

In various embodiments of the invention, the third-party-paid insurance coverage is provided in connection with one or more debt protection policies that are sold: (1) at a point of sale; (2) by inbound telemarketing; (3) via the Internet; (4) via a paper mail-in or store-deposited application; (5) by statement insert marketing; (6) by outbound telemarketing; and/or (7) at the time that a credit card covered by the debt protection contract is activated.

In certain embodiments of the invention, the debt protection contract may either be a provision in a credit agreement between a borrower and a creditor or an amendment to a credit agreement between the borrower and the creditor.

In one embodiment of the invention, the third-party-paid insurance coverage is provided on a group basis, in which case the borrower receives a certificate of insurance. In another embodiment of the invention, this insurance coverage is provided on an individual basis, in which case the borrower receives an insurance policy. In another embodiment of the invention, the third party paid insurance coverage is provided on a blanket basis, in which case the borrower receives a summary of benefits.

In a particular embodiment of the invention, the debt protection contract and the third-party-paid insurance coverage are provided by different providers. For example, in one embodiment, the debt protection contract is provided by a first entity and the third-party-paid insurance coverage is provided by a second entity. In another embodiment of the invention, a single provider provides both the debt protection contract and the third-party-paid insurance coverage.

Payment of Premiums

In a particular embodiment of the invention, the premium for the third-party-paid insurance coverage is not paid by the customer or by the insurer providing the third-party-paid insurance coverage. Rather, in one embodiment of the invention, the debt protection contract is associated with a credit account (e.g., a credit card account) issued by a creditor to a borrower (i.e., a customer), and the premiums for the third-party-paid insurance coverage are paid by the creditor. Alternatively, the premiums for the third-party-paid insurance coverage are paid by a retailer associated with a private label line of credit (e.g., a private label credit card) issued to the borrower. For example, Home Depot may offer to pay the premiums for a certain insurance coverage when a customer signs up for a Home Depot branded credit card account and purchases a debt protection contract associated with that credit card account.

As will be understood by one skilled in the relevant field in light of this disclosure, the premium for the third-party-paid insurance coverage may be payable monthly, in a single or annual payment, or according to any other appropriate schedule.

Payment of Benefits

The benefits payable under the terms of the third-party paid insurance coverage may vary according to the terms of the particular policy. However, in various embodiments of the invention, the benefit may be payable in the form of: (1) a cash payment; (2) a credit to the customer's credit card or other credit account; (3) a gift card; (4) credit card “points”, such as frequent flyer miles; (5) item replacement; (6) repair of the item, or (7) any other appropriate currency. The amount of the benefit paid will depend upon the terms of the third-party paid insurance coverage.

Relationship Between the Debt Protection Contract and the Third-Party-Paid-Insurance Coverage

In any of the embodiments of the invention described in this disclosure, the debt protection contract and the third-party-paid-insurance coverage may be provided within a single debt protection plan, which may, for example, be memorialized in a single agreement. For example, the debt protection contract may be embodied within a first provision of a single debt protection plan, and the third-party-paid insurance coverage may be memorialized within a second provision within that same debt protection plan. This single debt protection plan is preferably referenced by a single identification indicia (e.g., a single policy number), but may alternatively be referenced by more than one identification indicia (e.g., two different policy numbers). Alternatively, in any of the embodiments of the invention described in this disclosure, the debt protection contract and the third-party-paid insurance coverage may be provided within two or more separate policies, each of which may be memorialized in a separate insurance agreement

Effect of the Cancellation of the Debt Protection Contract

In one embodiment of the invention, if the debt protection contract is cancelled in its entirety, (e.g., by the customer or the creditor) the related third-party-paid insurance coverage will automatically terminate. However, in a particular embodiment of the invention, if the customer reduces the scope of their debt protection contract by canceling one or more, but not all, of the benefits under the debt protection contract, the third-party-paid insurance coverage will remain in effect as long as the creditor or other third party continues to pay the premiums associated with the debt protection contract. For example, in this embodiment, the insurance coverage will remain in effect if the customer cancels a disability benefit associated with the debt protection contract, but retains other benefits (such as an unemployment benefit) associated with the debt protection contract. In an alternative embodiment of the invention, the third-party-paid insurance coverage will automatically terminate in response to the customer reducing the scope of their debt protection contract.

Effect of the Termination of the Third Party Paid Insurance Coverage

In a particular embodiment of the invention, if the third party who is providing the third-party-paid insurance coverage terminates the insurance coverage or causes this insurance coverage to lapse for non-payment of premium, the debt protection contract will remain in effect as long as the borrower continues to pay the applicable fees.

### CONCLUSION

Many modifications and other embodiments of the invention will come to mind to one skilled in the art to which this invention pertains having the benefit of the teachings presented in the foregoing descriptions and the associated drawings. For example, as described above, in various embodiments, insurance coverage is provided to the customer at no cost, or at substantially no cost, to the customer. However, in various embodiments of the invention, the step of providing insurance coverage to the customer may done at a cost to the customer. For example, in various embodiments of the invention, the insurance coverage may be provided to the customer at the current market value for the insurance coverage, or at a discounted cost (e.g., a discounted cost that is substantially below market value for the insurance coverage).

Accordingly, it should be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

We claim:

1. A method of providing insurance coverage to a customer, said method comprising the steps of:
selling a debt protection contract to a customer;
purchasing insurance coverage that provides benefits to said customer, said insurance coverage being selected from a group consisting of: property insurance coverage, casualty insurance coverage, and health insurance coverage; and
in response to said customer purchasing said debt protection contract, providing said insurance coverage to said customer at no cost to said customer.

2. The method of claim 1, wherein said insurance coverage comprises property insurance coverage.

3. The method of claim 1, wherein said insurance coverage comprises casualty insurance coverage.

4. The method of claim 1, wherein said insurance coverage comprises health insurance coverage.

5. The method of claim 1, wherein said step of providing said insurance coverage to said customer is done by a party that has an insurable interest in property that is covered by said insurance coverage.

6. The method of claim 5, wherein said party has obtained said insurable interest in said property by virtue of a relationship between said party and said customer.

7. The method of claim 1, wherein said step of providing said insurance coverage to said customer is done by a party that has an insurable interest in a person that is covered by said insurance coverage.

8. The method of claim 7, wherein said party has obtained said insurable interest in said person by virtue of a relationship between said party and said customer.

9. The method of claim 1, wherein said step of providing said insurance coverage is done in order to permit the provision of said insurance coverage to said customer without a sale of said insurance coverage by an insurance agent.

10. The method of claim 1, wherein said debt protection contract is a debt deferment contract.

11. The method of claim 1, wherein said debt protection contract is a debt cancellation contract.

12. The method of claim 1, wherein said debt protection contract is a debt holiday contract.

13. The method of claim 1, wherein:
said debt protection contract is associated with a credit card issued to said customer by a creditor; and
said insurance coverage is paid for by said creditor.

14. The method of claim 1, wherein:
said debt protection contract is associated with a private label credit card issued to said customer; and
said insurance coverage is paid for by a retailer associated with said private label credit card.

15. The method of claim 1, wherein:
said debt protection contract is associated with a revolving line of credit issued to said customer by a creditor.

16. The method of claim 1, wherein:
said debt protection contract is associated with an installment loan issued to said customer by a creditor.

17. The method of claim 1, wherein:
said debt protection contract is associated with a mortgage loan to said customer by a creditor.

18. The method of claim 1, wherein said insurance coverage provides for one or more payments to be made in response to said customer becoming disabled.

19. The method of claim 18, wherein:
said debt protection contract is associated with a credit account issued to said customer; and
said one or more payments comprises a credit to said credit account.

20. The method of claim 1, wherein said insurance coverage provides for one or more payments to be made in response to said customer becoming disabled.

21. The method of claim 1, wherein said insurance coverage provides for one or more payments to be made in response to said customer becoming involuntarily unemployed.

22. The method of claim 21, wherein said one or more payments are made to purchase health insurance for said customer.

23. The method of claim 1, wherein said insurance coverage provides for one or more payments to be made in response to said customer becoming divorced.

24. The method of claim 1, wherein said insurance coverage provides for one or more payments to be made in response to said customer taking a leave of absence from work.

25. A debt protection plan comprising:
debt protection coverage that is paid for by a first entity; and
insurance coverage that is paid for by a second entity.

26. The debt protection plan of claim 25, wherein said debt protection plan is referenced by a single identification indicia.

27. The debt protection plan of claim 25, wherein said debt protection coverage comprises a debt cancellation contract.

28. The debt protection plan of claim 25, wherein said debt protection coverage comprises a debt deferment contract.

29. The debt protection plan of claim 25, wherein said debt protection coverage is associated with a credit card issued to said first entity by said second entity.

30. The debt protection plan of claim 25, wherein:
said debt protection coverage is associated with a private label credit card issued to said first entity; and
said second entity is a retailer associated with said private label credit card.

31. The debt protection plan of claim 25, wherein said insurance coverage comprises property insurance.

32. The debt protection plan of claim 25, wherein said insurance coverage comprises casualty insurance.

33. The debt protection plan of claim 25, wherein said insurance coverage provides for one or more payments to be made in response to said first entity becoming disabled.

34. The debt protection plan of claim 25, wherein said insurance coverage provides for one or more payments to be made in response to said first entity becoming involuntarily unemployed.

35. The debt protection plan of claim 25, wherein said insurance coverage provides for one or more payments to be made in response to said first entity taking a specified leave of absence.

36. The debt protection plan of claim 25, wherein said insurance coverage provides for one or more payments to be made in response to said first entity obtaining a divorce.

37. The debt protection plan of claim 25, wherein:
said debt protection coverage is associated with a credit account issued to said first party; and
said insurance coverage provides for one or more payments to be made in response to particular property being damaged, said particular property having been purchased by said first party and charged to said credit account.

38. The debt protection plan of claim 25, wherein:
said debt protection coverage is associated with a credit account issued to said first party; and
said insurance coverage provides for one or more payments to be made in response to particular property mysteriously disappearing, said particular property having been purchased by said first party and charged to said credit account.

39. The debt protection plan of claim 25, wherein:
said debt protection coverage is associated with a credit account issued to said first party; and
said insurance coverage provides for one or more payments to be made in response to particular property being lost, said particular property having been purchased by said first party and charged to said credit account.

40. The debt protection plan of claim 25, wherein said debt protection plan provides that said insurance coverage will be canceled in response to said first party canceling said debt protection coverage.

41. A method of providing insurance coverage to a customer, said method comprising the steps of:
selling a debt protection contract to a customer;
purchasing insurance coverage that provides benefits to said customer, said insurance coverage being selected from a group consisting of: property insurance coverage, casualty insurance coverage, and health insurance coverage; and
in response to said customer purchasing said debt protection contract, providing said insurance coverage to said customer.

42. The method of claim 41, wherein said step of providing said insurance coverage to said customer comprises providing said insurance coverage to said customer at substantially no cost to said customer.
